(19) United States
(12) Patent Application Publication
(10) Pub. No.: US 2017/0082483 A1
(43) Pub. Date: Mar. 23, 2017

(54) SCALE WITH INFORMATION CARRIER

(71) Applicant: seca ag, Reinach BL 1 (CH)

(72) Inventor: Frederik VOGEL, Coburg (DE)

(21) Appl. No.: 15/266,155

(22) Filed: Sep. 15, 2016

(30) Foreign Application Priority Data
Sep. 17, 2015 (DE) 10 2015 012 128.6

(51) Int. Cl. G01G 23/36; G01G 21/28

(52) U.S. Cl. CPC G01G 23/361; G01G 21/28

(57) ABSTRACT

A scale with at least one information carrier for providing data in optical, visual, or optoelectronic form, wherein the at least one information carrier is attachable in the viewing area of at least one element of the scale.

### CROSS-REFERENCE TO RELATED APPLICATIONS

The present application claims priority of DE 10 2015 012 128.6, filed Sep. 17, 2015, the priority of this application is hereby claimed and this application is incorporated herein by reference.

### BACKGROUND OF THE INVENTION

The invention pertains to a scale with at least one information carrier for providing data in optical, visual, or optoelectronic form.

Both mobile and stationary measuring devices are used to measure physical properties and/or body functions of subjects, e.g., human beings or animals. The properties or functions to be measured are often bioimpedances or body impedances, heart functions, nerve functions, and electrocardiograms. Other measurement variables in this context can be body weight, body composition, geometric dimensions, fingerprints, body temperatures at various points, the composition of exhaled breathing gas, breathing gas volumes, blood pressure values, etc.

If, of the possible physical properties of a subject or of an object, only the body weight is to be determined by a measuring instrument, scales have become the standard choice. Scales for determining the body weight of a subject or object can be configured for private use and in these cases are referred to as “home scales”. Scales are also commonly found in hospitals, for example, for professional or semi-professional use or in nursing care facilities or medical practices.

In particular but not exclusively in professional or semi-professional applications, measurement devices for determining body weight as one of the possible physical properties of a subject are configured solely for this purpose. To this end, the structure, the weighing range, and the measurement accuracy are adapted to meet the concrete requirements. In private applications, different types of home scales are often used, configured to perform various weight-measuring tasks such as to weigh people, letters, or food items.

Regardless of the area of application or of the configuration as mobile or stationary measurement recording devices, scales in their basic structure are often formed by a base and a display unit, wherein the base contains the devices necessary for determining a weight.

Physically, the weight of a body is its weight force, which experiences a location-dependent acceleration as a result of the gravitational force of the earth. It would be possible to measure the mass of a body directly by determining the volume and the specific gravity of this body. Scales usually determine the weight of a body by measuring the weight force as part of a deformation measurement. This measurement method used by most scales determines the deformation distance of a spring, resulting from the weight force acting on it, against the approximately constant, i.e., linear, spring characteristic. The mass is calculated by dividing the spring constant by the deformation distance. This means that, for a weight determination, it is also to be expected that, in most cases, a spring or some other elastic object with a spring constant will be subjected to deformation.

In modern scales, at least one load cell is frequently used, which is arranged under the support surface. The support surface or scale platform serves to receive and hold the body to be measured, and during a weight measurement it drops down by an amount equal to the deformation of the load cell.

The at least one load cell, the scale platform, and the other measurement detection components are usually arranged inside the base, i.e., are enclosed or housed by it. The display unit can be an integral part of the base or configured as a separate component; it has the primary task of displaying the determined measurement variable—usually in optically perceivable form. If the display unit is configured as a separate component, suitable transmission means must be provided between the base and the display unit, so that at least the measurement result to be displayed can be sent from the base to the display unit. In addition to the reliable methods based on cables or wires, there are also wireless transmission connections which can also be considered.

It is very often necessary to provide home scales or laboratory balances with at least one information carrier. These information carriers must fulfill different tasks, depending on the area of application and on the location where the scale is used, and they must contain one, several, or many items of information, definitions, and/or instructions.

This large amount of information, definitions, and/or instructions can be subsumed under the collective term “data”.

Such information carriers can perform a very wide range of functions: Assignment information concerning location, area of application, or organizational unit can be displayed; in addition, data or ID information carriers can be necessary to assign the individual scale to an external display unit which may be provided or to a certain inventory group or to identify property or ownership relationships; warnings, user instructions, or operating steps can also be communicated by means of information carriers.

To ensure that the information carrier improves the manageability of the scale and supports the user in its use, it can be especially advantageous to provide at least one information carrier within the viewing area of the scale to support the optical, visual, or optoelectronic and possibly even haptic communication of data in the standby state or during the measurement process itself.

Scales are often equipped with nameplates and/or serial number information of the manufacturer, but they do not perform any of the other tasks which may be required, nor can they be individualized, and are frequently mounted permanently on the rear of the base component and thus out of the viewing area.

In the case of bases in the form of transparent glass or plastic panels, such information carriers can also be attached to the bottom surface without causing any significant negative effect on visibility.

So that the scales in a medical practice, for example, or in a hospital can be individually identified by means of lettering, such identifying information is provided by the use of felt-tipped pens. This does not improve the appearance of the scale, and the effects of sterilizing agents means that such lettering does not prove to be permanent. The ease with which such lettering can be removed, furthermore, means that it is not a suitable method of establishing authenticity or originality.

### SUMMARY OF THE INVENTION

The goal of the present invention is to provide an information carrier for scales which fulfills the above-cited identification requirements at least in part and which reduces the disadvantages of the previous solutions.

For this purpose, the teaching according to the invention proposes an information carrier which is adapted to be mountable, reversibly or irreversibly, on a scale and within the viewing area available during use or in the standby state, and which is able to display at least one of the previously cited, possibly individualizable, pieces of information, definitions, or instructions, preferably in visual, optoelectronic, or optical fashion.

The expression “mechanically mountable” as used for the information carrier according to the invention denotes an at least temporary, nonvolatile lettering or symbol display which is detectable optically, visually, or optoelectronically. For this purpose, the invention provides, for example, letterings in suitable permanent inks, protective covers, nameplates with engravings or stamped-out areas, partial elevations, color patterns, barcodes, directly lettered adhesive foils, or suitable powder coatings.

Especially advantageous is the possibility of making available information, definitions, or instructions in a manner tailored to the individual context. For this purpose, the invention provides that the content of the information carrier can be specified by the user, owner, or buyer of one or of many home or laboratory scales; this can be done, for example, as part of the purchasing process itself over the Internet. In this way, it is possible in an especially effective manner to personalize or to individualize the labeling in a manner consistent with the function of the specific information carrier in question.

To ensure that the information carrier according to the invention supports the user and improves the manageability of the scale, it is proposed in particular that an information carrier be provided in the viewing area of the home or laboratory scale to support the optical, optoelectronic, visual, or possibly even haptic communication of the desired information in the standby state or during the measurement process itself.

The viewing area of a scale comprising a base is usually its top surface, which frequently also serves as a support surface for the subject or object to be measured and which consists of a profiled elastic material. The invention provides an information carrier which is either elevated, flush, or suitably recessed, and which can be formed by direct application or by applying an adhesive foil or lettered plate.

The lettered plate can be fastened by using an adhesive, rivets, or screws, or it can be embedded in a receiving frame integrated into the elastic surface material of the base or of the display unit, wherein both reversible and irreversible mounting options can be realized, depending on the requirements. Suitable lettered plates include any deformable or rigid curved elements or inserts made of plastic or metal materials.

If the information carrier is configured as a lettered plate, the invention provides an attachment method of particular interest for series production: melt-bonding. For this purpose, the lettered plate is heated to a temperature above the melting temperature of the material onto which the information carrier is to be applied. The thermal energy introduced into the lettered plate can be combined with mechanical pressure, and when the plate is applied to the base and/or to the display unit, some of the surrounding material melts. When this material cools, a permanent bond is produced.

Depending on the joining pressure applied or on the joining distance, the information carrier configured as a lettered plate can rest on top of the surface of the partner material, be flush with that surface, or be recessed into it. This attachment method is especially low in cost, because the base and/or the display unit, as partner material, can be equipped with the information carrier without the need for any special preparatory steps such as the production of a cut-out.

If an irreversible information carrier is realized, the information content to be communicated optically, optoelectronically, or visually can consist, for example, of ownership or property relationships, i.e., the name of a hospital or medical practice to which the scale belongs or the name of the individual to whom it belongs, or it can contain information indicating the hospital ward to which the scale is assigned. The same also applies to calibration information, operating instructions, location-dependent information concerning measurement accuracy, or specific settings for obtaining the measurements. Location-specific information with a bearing on measurement accuracy can consist of a geographical location or altitude, because the force of gravity differs at different places, and therefore the scale must be adjusted in a location-specific manner to ensure a highly accurate measurement.

An especially important irreversible property of the information carrier can be relative to necessary cleaning processes, especially the action of sterilizing agents such as H2O2. If such requirements are imposed, the invention provides an information carrier in the form of, for example, a lettered plate with engraved information or a carrier with a protective covering which is resistant to sterilization measures.

Reversible information carriers can be good choices when the required content of the information carrier is temporary, such as variable pre-tare values or warnings about the possible danger of slipping after a wet cleaning.

Other possible applications of reversible or irreversible information carriers according to the teaching of the present invention can be found in cases where the bases and display units of the laboratory, personal, or home scales are configured as separate elements with a wireless device for measurement data transmission. In these cases, information carriers can be used to assign the elements in question to each other.

In situations where more than one laboratory, personal, or home scale, each with a display unit configured not in the base but rather as an external element, are present or are being operated in parallel, the information carriers according to the invention are especially effective at reliably preventing assignment errors. This assignment function is especially important, because otherwise a weight value which has been measured accurately in itself can be confused with one or more other measurement values determined in parallel and thus be assigned to the wrong subject or object.

A single, independent information carrier according to the teaching of the invention can be provided, or multiple carriers can be provided on the base and/or on the display unit. At least one information carrier, however, can also cooperate functionally or informatively with one of the scale components or with any supplemental device which may also be present.

For example, an information carrier can cooperate with the display unit in that startup information, preparatory steps for acquiring the measurement, or instructions for interpreting the measurement value being displayed in an individual case can be offered by the information carrier.

Another possibility of functional cooperation between an information carrier and a scale arises from the use of a supplemental device in the form of a bubble level as a component in the viewing area of the base. Bubble levels are known in the prior art and to the person skilled in the art as measuring instruments based on the principle of the water level. Bubble levels are able to determine the level in two directions of space, which thus generates a plane; the position of an air bubble in a hemispherical, liquid-filled body is adjusted to coincide with a reference mark representing the zero level, which, when reached, means that the generated plane is precisely horizontal.

The principle of measuring the deformation of a spring element arranged in a load cell inside the base is usually employed in scales of this type; it requires that the subject or object to be measured be oriented at a right angle to the support surface, which can be achieved by aligning this support surface with the zero level. This alignment is often realized by changing the height of the adjustable support feet of the base, the correct adjustment of which is checked by means of the bubble level for determining horizontality. Appropriate operating and setting options can be provided on the base in direct proximity to the bubble level instrument and can be provided by the information carrier according to the invention.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows a first exemplary embodiment of the information carrier 1 according to the invention based on the example of a laboratory, personal, or home scale 100 in a configuration consisting of essentially two separate elements, i.e., a base 20 and a display unit 30, with wireless data transmission between the base 20 and the display unit 30;

FIG. 2 shows a second exemplary embodiment of the information carrier 1 according to the invention based on the example of a laboratory, personal, or home scale 100 in a configuration consisting of essentially two elements, a base 20 and a display unit 30 with hard-wired information transmission between the base 20 and the display unit 30 and also with devices 23, 24 for leveling the base 20 to a horizontal position;

FIG. 3 shows another exemplary embodiment of the information carrier 1 according to the invention based on the example of a laboratory, personal, or home scale 100 in a configuration consisting of essentially two elements, i.e., a base 20 and a display unit 30 configured as an integrated unit, and with devices 23, 24 for leveling the base 20 to a horizontal position;

FIG. 4 shows an exemplary embodiment of the information carrier 1 according to the invention based on the example of a laboratory, personal, or home scale 100 in a configuration consisting of essentially two elements, i.e., a base 20 and a display unit 30 configured as an integrated unit; and

FIG. 5 shows a simplified cross-sectional diagram of the exemplary embodiment of FIG. 4.

### DETAILED DESCRIPTION OF THE INVENTION

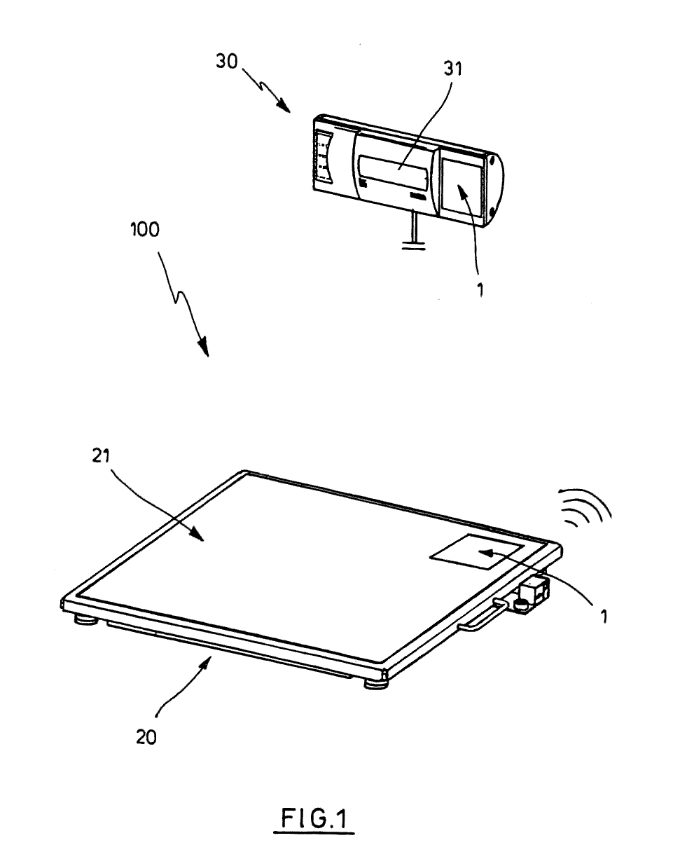

FIG. 1 shows a first exemplary embodiment of the information carrier 1 according to the invention based on the example of a laboratory, personal, or home scale 100 in a configuration consisting of essentially two separate elements, i.e., a base 20 and a display unit 30, with wireless data transmission between the base 20 and the display unit 30. To ensure that the two elements 20, 30 of the laboratory, personal, or home scale 100 can be reliably assigned even when several such scales are present, it is provided that the information carriers 1 carrying the appropriate assignment information are attached both to the base 20 and to the display unit 30 in nonvolatile, preferably irreversible and mechanical fashion.

So that the assignment information of the information carriers 1 can be detected or compared preferably visually, optically, or optoelectronically during the measurement process itself, both the information carrier 1 on the base 20 and the one on the display unit 30 are provided in the viewing area. “Viewing area” in this context means the area in which the information of the information carrier is visually, optically, or optoelectronically accessible.

In the case of the display unit 30, this means that the information carrier 1 is either arranged on the same side as the measurement value display 31 or at least has a similar orientation, i.e., an orientation in which it is facing the operator, the measurement subject, or an optoelectronic recording unit.

In the case of the base 20, this means that the information carrier 1 is preferably arranged on the top surface 21 of the base in such a way that it will not be covered by the subject or object to be measured.

The individual information carrier 1 on the base 1 and/or on the display unit 30 can be configured in various ways according to the invention. For example, the individual information carrier 1 can be realized by the use of suitable permanent ink and possibly provided with a cover for protection against mechanical, chemical, or any other type of effect; it could also be realized as a plate with engravings or stamped-out areas or with partial elevations, color patterns, or barcodes; or it could be provided in the form of a directly lettered adhesive foil or a suitable powder coating.

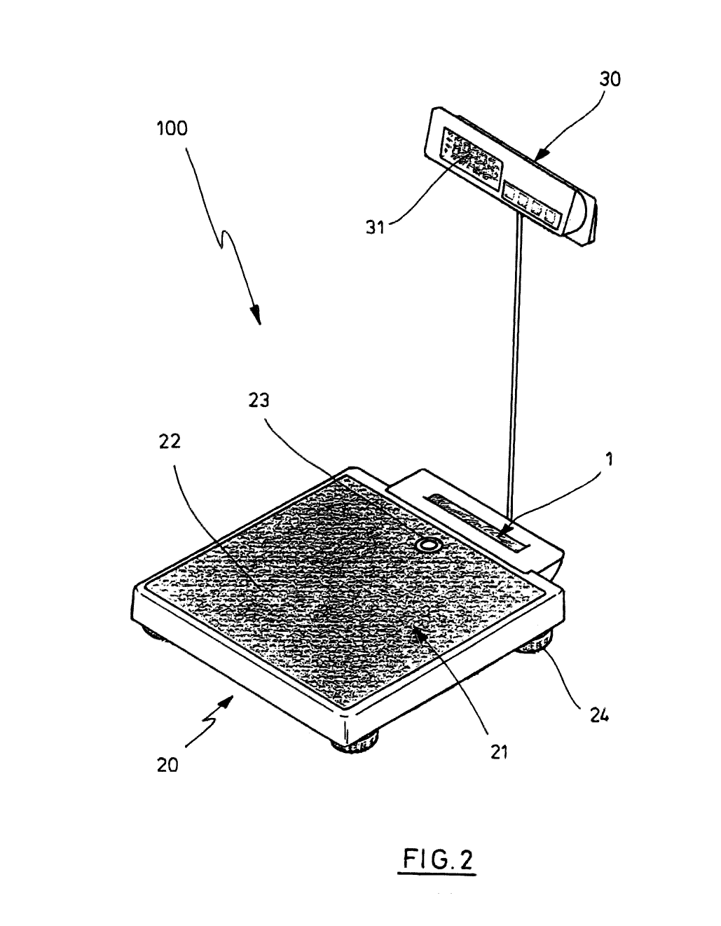

FIG. 2 shows a perspective view of a second exemplary embodiment of the information carrier 1 according to the invention based on the example of a laboratory, personal, or home scale 100 in a configuration consisting of essentially two elements, i.e., a base 20 and a display unit 30, with hard-wired data transmission between the base 20 and the display unit 30 and also with devices 23, 24 for leveling the base 20 to a horizontal position. The information carrier 1 in this exemplary embodiment is attached to an upward-facing surface of the base 20 in the viewing area and can in particular comprise handling instructions for leveling the base by means of the height-adjustable feet 24, the correct, i.e., horizontal, position of which is indicated by the bubble level 23 mounted in the top surface 21 of the base and in the support mat 22. In this way, at least one information carrier 1 cooperates functionally and informatively with the bubble level 23 as a scale element.

Alternatively or in addition, additional information or warnings can form part of the content of the information carrier 1, such as cleaning instructions, warnings, pre-tare values, startup information, property or ownership identification, etc.

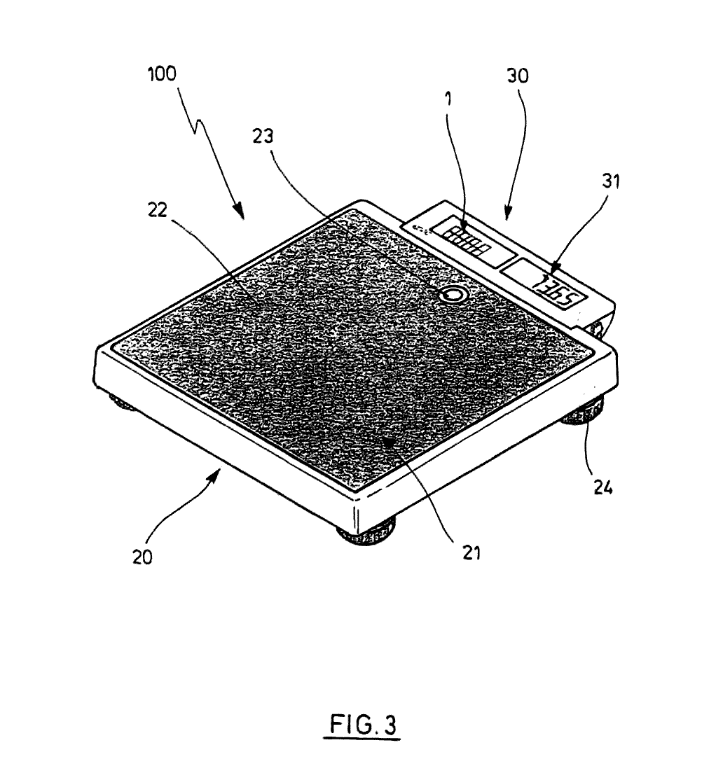

FIG. 3 shows another exemplary embodiment of the information carrier 1 according to the invention based on the example of a laboratory, personal, or home scale 100 in a configuration consisting of essentially two elements, a base 20 and a display unit 30, configured as an integrated unit and also with devices 23, 24 for adjusting the level of the base 20 to a horizontal position. This exemplary embodiment shows the information carrier 1 attached to a surface on top of the base 20 in the viewing area and in immediate proximity both to the measurement value display 31 and to the measuring instrument in the form of a bubble level 23.

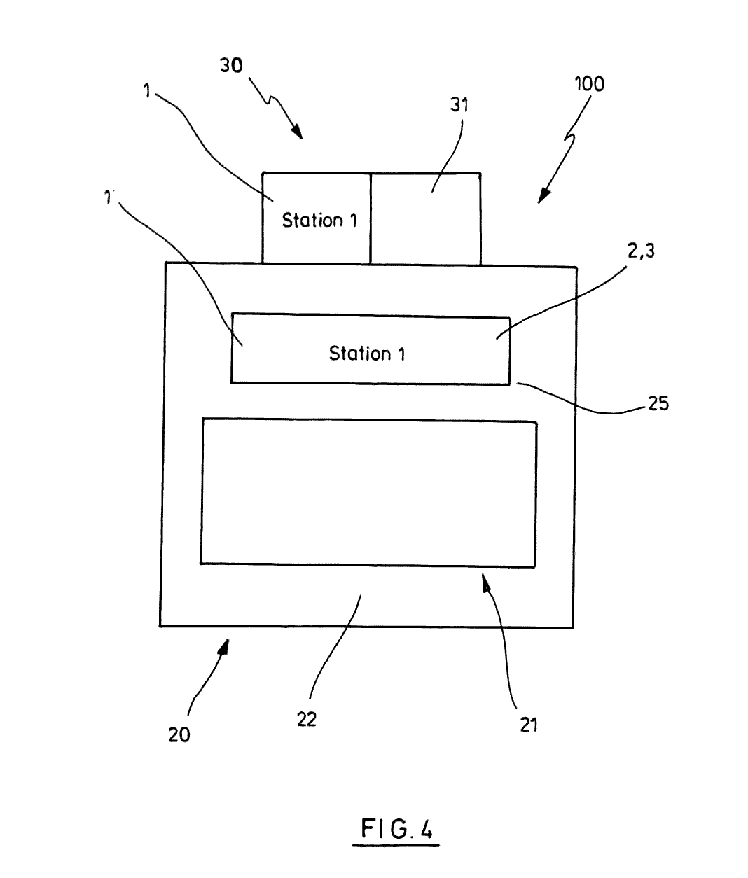

FIG. 4 shows a highly simplified line diagram of an exemplary embodiment of the information carrier 1 according to the invention based on the example of a laboratory, personal, or home scale 100 in a configuration consisting of essentially two elements, i.e., a base 20 and a display unit 30, configured as an integrated unit. The information carrier 1 according to the invention is arranged here in a depression 25, i.e., a recess inside the support mat 22 on the top of the base 21, in the viewing area, and is configured as an inlay part 3.

The inlay part 3 can be formed by a lettered plate 2 and optionally can comprise a protective cover (not shown). The depression 25 within the support mart 22 on top of the base 21 is preferably arranged in the first third of the support surface 21, adjacent to the display unit 30, so that it will be viewable even when the measurement is being taken and the subject or object is present. As a result of the preferred arrangement in the first third of the support surface, the information carrier 1 will not be hidden by the subject or object to be measured.

FIG. 4 also shows an optional, possibly additional or alternative, information carrier 1 in the viewing area of the display unit 30. Two information carriers 1 can be advantageous especially when both reversible and irreversible information, instructions, or operating steps must be communicated visually, optically, or optoelectronically—such as irreversible location information and a reversible pre-tare value, which is valid only temporarily.

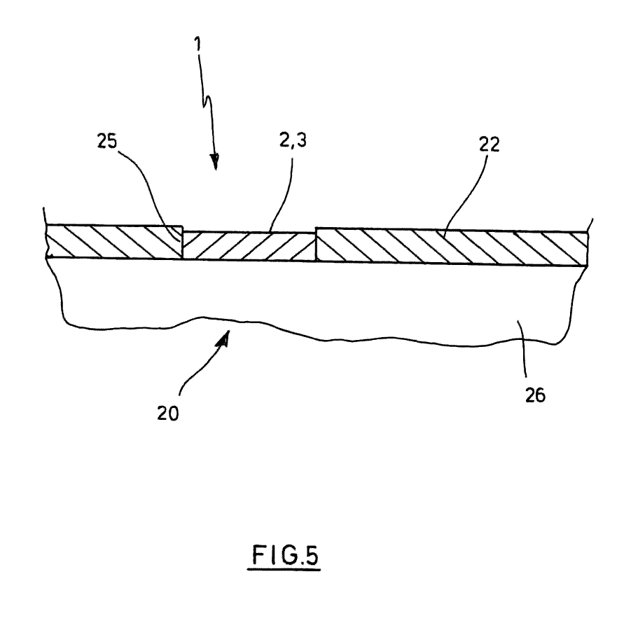

FIG. 5 shows the exemplary embodiment of FIG. 4 as a simplified cross-sectional diagram. What is shown is the information carrier 1 according to the invention in a form in which it is recessed into the depression 25 within the support mat 22 on top of the base 21. The information carrier 1, configured as an inlay part 3 or lettered plate 2, can be recessed as shown; or, depending on the wall thickness, it can be flush with the support mat 22 or even elevated with respect to it in either relative or absolute terms.

The information carrier 1 can be inserted, for example, into a previously produced recess 25 and fastened there by an adhesive. The carrier can be bonded either to the base body 26 or to the end surfaces of the recess 25 or to both.

As an alternative bonding method, the invention proposes the method of melt-bonding. For this purpose, the lettered plate 2 is brought to a temperature above the melting temperature of the material of the support mat 22 and possibly also of the base body 26 and then, under the action of mechanical pressure, it is pressed into the support mat 22 and/or into the base body 26. As a result of the local melting and then cooling of the materials of the support mat 22 and/or of the base body 26, a permanent bond is formed, and simultaneously the recess 25 is formed by the displacement of the melted material. In this way, the preparatory step of producing the recess 25 is eliminated, and it is also possible for the information carrier 1 to be positioned very flexibly according to the customer's wish, for example.

While specific embodiments of the invention have been shown and described in detail to illustrate the inventive principles, it will be understood that the invention may be embodied otherwise without departing from such principles.

I claim:

1. A scale, comprising; at least one element; and at least one information carrier for providing data, wherein the at least one information carrier supports optical, visual, or optoelectronic detection of the provided data, wherein the at least one information carrier is attachable in a viewing area of the at least one element of the scale.

2. The scale according to claim 1, wherein the at least one information carrier is attachable in the viewing area to at least one element of the scale so that the optical, visual, or optoelectronic detection of the provided data is supported before and/or during a measurement process.

3. The scale according to claim 1, wherein the at least one element is a base, the at least one information carrier is attachable in the viewing area to the base in an area of a support surface.

4. The scale according to claim 1, wherein the at least one element is a base having a support mat, the at least one information carrier is attachable in the viewing area to the base in an area of the support mat.

5. The scale according to claim 3, wherein the at least one information carrier is attachable in the viewing area to the base in the area of a base body.

6. The scale according to claim 1, wherein the at least one element is a base, the at least one information carrier is attachable in the viewing area to the base in a recess.

7. The scale according to claim 1, wherein the at least one element is a display unit, the at least one information carrier being attachable in the viewing area to the display unit.

8. The scale according to claim 1, wherein the at least one information carrier is attachable in an elevated, flush, or recessed manner.

9. The scale according to claim 1, wherein the at least one information carrier is formed by a curved plate.

10. The scale according to claim 1, wherein the at least one information carrier is formed by an adhesive foil.

11. The scale according to claim 1, wherein the at least one information carrier is configured as an inlay part.

12. The scale according to claim 1, wherein the at least one information carrier is attachable in the viewing area of the at least one element of the scale by melt-bonding, adhesive bonding or by screwing.

13. The scale according to claim 1, wherein the data of the at least one information carrier comprises information relating to startup and/or handling instructions for measurement value detection and/or user information.

14. The scale according to claim 1, wherein the data of the at least one information carrier comprise definitions relating to pre-tare values, zero-position values, or preset measurement accuracy values.

15. The scale according to claim 1, wherein the data of the at least one information carrier comprise instructions for using a measuring instrument, so that the at least one information carrier cooperates functionally with the measuring instrument.

16. The scale according to claim 1, wherein the data of the at least one information carrier comprise information relating to an assigned location, an assigned organizational unit, or ownership or property relationships.

17. The scale according to claim 1, wherein the data of the at least one information carrier are formed by a barcode.

18. The scale according to claim 1, wherein the data of the at least one information carrier are resistant to cleaning agents and/or sterilizing agents.

19. The scale according to claim 1, further comprising a protective cover on the at least one information carrier to protect the data from environmental influences and/or cleaning agents and/or sterilizing agents.

20. The scale according to claim 1, wherein the least one information carrier and/or optically, visually, or optoelectronically detectable data are set reversibly or irreversibly.

21. The scale according to claim 1, wherein the data are individually definable by a user or buyer.
